(19) United States
(12) Patent Application Publication
(10) Pub. No.: US 2025/0317981 A1
(43) Pub. Date: Oct. 9, 2025

(54) SYSTEM INFORMATION INDICATION OF PHYSICAL RANDOM ACCESS CHANNEL ADAPTATION

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Hung Dinh LY, San Diego, CA (US)

(21) Appl. No.: 18/628,610

(22) Filed: Apr. 5, 2024

(51) Int. Cl. H04W 74/0833; H04W 48/08

(52) U.S. Cl. CPC H04W 74/0833; H04W 48/08

(57) ABSTRACT

The present disclosure provides techniques for wireless communications. A method includes receive, from the network entity, a first message comprising physical random access channel (PRACH) adaptation information, the PRACH adaptation information comprising: a first PRACH configuration; and an indication of an activation state for PRACH adaptation, wherein the indication of the activation state for PRACH adaptation indicates whether one or more PRACH adaptations are active with respect to the first PRACH configuration; and performing a random access channel (RACH) procedure based on the PRACH adaptation information.

### BACKGROUND

### Field of the Disclosure

Aspects of the present disclosure relate to wireless communications, and more particularly, to techniques for indicating one or more adaptations to a physical random access channel (PRACH) configuration.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving, from the network entity, a first message comprising physical random access channel (PRACH) adaptation information, the PRACH adaptation information comprising: a first PRACH configuration; and an indication of an activation state for PRACH adaptation, wherein the indication of the activation state for PRACH adaptation indicates activation or deactivation of one or more PRACH adaptations; and performing a random access channel (RACH) procedure based on the PRACH adaptation information.

Another aspect provides a method for wireless communications by an apparatus. The method includes receiving, from the network entity, a message comprising PRACH adaptation information, the PRACH adaptation information comprising: a default PRACH configuration; an indication of an activation state for PRACH adaptation, wherein the indication of the activation state for PRACH adaptation indicates activation or deactivation of one or more PRACH adaptations; and an indication of a time period for which the indication of the activation state for PRACH adaptation is valid; performing one or more RACH in accordance with the indication of the activation state for PRACH adaptation prior to the time period elapsing; and receiving, from the network entity, a system information update message indicating one or more updates have been made to a system information message, wherein the time period is shortened based at least in part on receiving the system information update message.

Another aspect provides a method for wireless communications by an apparatus. The method includes sending, to a device, a first message comprising PRACH adaptation information, the PRACH adaptation information comprising: a first PRACH configuration; and an indication of an activation state for PRACH adaptation, wherein the indication of the activation state for PRACH adaptation indicates activation or deactivation of one or more PRACH adaptations; and performing a RACH procedure with the device based on the PRACH adaptation information.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications system.

FIG. 6 depicts an example indication of an adaptation for a physical random access channel (PRACH) configuration.

FIG. 7 depicts an example adaptation for a PRACH configuration.

FIG. 8 depicts a process flow for communications in a network between a network entity and a device.

FIG. 9 depicts a method for wireless communications.

FIG. 10 depicts another method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for indicating one or more adaptations to a physical random access channel (PRACH) configuration. In particular, certain aspects provide for a device to receive a message that includes PRACH adaptation information and to perform a random access channel (RACH) procedure based on the PRACH adaptation information. For example, the PRACH adaptation information may at least include a first PRACH configuration (e.g., legacy PRACH configuration) and an indication of an activation state for PRACH adaptation, where the indication of the activation state for PRACH adaptation indicates activation or deactivation of one or more PRACH adaptations. In some aspects, when the indication of the activation state for PRACH adaptation indicates activation, the device may apply and/or activate the one or more PRACH adaptations (e.g., indicated in the PRACH adaptation information) for performing RACH procedures. In some aspects, the one or more PRACH adaptations may be indicated as one or more adaptation parameters that the device is expected to apply and/or activate or may be indicated as one or more separate PRACH configurations.

As described herein, PRACH adaptation may be used to optimize a number of RACH occasions (ROs) (e.g., time-frequency resources configured for a device to perform a RACH procedure to establish a connection with a network entity) based on an identified need by a network entity. For example, a PRACH configuration may include a number of configured ROs, and the PRACH adaptation may include adjusting the number of configured ROs (e.g., increase or decrease the number of configured ROs) based on the identified need by the network entity.

In some aspects, a PRACH configuration may include a configuration of ROs with a small number of configured ROs, and the PRACH adaptation may dynamically add more ROs to the PRACH configuration based on an identified need by a network entity. For example, the identified need to increase a number of ROs may be caused by a greater number of devices entering a coverage area of the network entity, and the greater number of device may then attempt to perform respective RACH procedures to connect to the network entity. Thus, the increased number of ROs may reduce a chance that the respective RACH procedures interfere with each other and/or may provide more opportunities for the greater number of devices to perform the respective RACH procedures, thereby increasing a likelihood that the respective RACH procedures are successful. Additionally or alternatively, the identified need to increase the number of ROs may be caused by the network entity identifying an increase in downlink traffic to be sent to devices located in a coverage area of the network entity and/or an increase in expected uplink traffic from the devices. Accordingly, the increased number of ROs may increase a likelihood that the devices can successfully perform respective RACH procedures to then receive downlink messages from the network entity and/or send expected uplink messages to the network entity.

In some aspects, a PRACH configuration may include a configuration of ROs with a large number of configured ROs, and the PRACH adaptation may dynamically reduce and/or remove ROs (e.g., mute one or more configured ROs) based on an identified need by a network entity. For example, the identified need to reduce and/or remove a number of ROs may be caused by a decrease in a number of devices being in a coverage area of the network entity, such that the dense configuration of ROs is excessive or no longer needed for the decreased number of devices. Additionally or alternatively, the identified need to reduce and/or remove a number of ROs may be caused by the network entity identifying a decrease in downlink traffic to be sent to devices located in a coverage area of the network entity and/or a decrease in expected uplink traffic from the devices. Accordingly, in these described situations, the reduced and/or removed number of ROs may reduce signaling for the network entity and reduce a number of ROs that the network entity is expected to monitor.

In some aspects, the above described examples of adjusting a number of configured ROs may include adapting PRACH configurations in a time domain. For example, adapting the PRACH configuration may include increasing or reducing a periodicity of ROs, which may result in adjusting the number of configured ROs for a given time duration. That is, a higher periodicity may correspond to a higher number of configured ROs for the given time duration, and a lower periodicity may corresponding to a lower number of configured ROs for the given time duration.

Additionally or alternatively, adapting PRACH configurations may be performed in a spatial domain. In some aspects, the network entity may send synchronization signals to devices in a coverage area of the network entity, where the synchronization signals are sent via respective beams. The synchronization signals and corresponding beams may be associated with one or more respective ROs, such that the device may determine which ROs to use for performing a RACH procedure based on which synchronizations signals are received and/or on which beams the synchronization signals are received. For example, a first set of synchronization signals may be sent via a first beam from the network entity, and the first set of synchronization signals and/or first beam may correspond to one or more first ROs, such that a device receiving the first set of synchronization signals via the first beam may determine to use the one or more first ROs to perform a RACH procedure to connect to the network entity.

Accordingly, the adaptation of PRACH configurations may include adding or removing one or more ROs and/or PRACH resources that are mapped to corresponding beamformed transmissions (e.g., beams carrying synchronization signals that correspond to ROs). For example, the network entity may adjust how many ROs or which ROs are mapped to the synchronization signals and/or corresponding beams. Subsequently, a device receiving the synchronization signals via the corresponding beams may determine to use the adjusted ROs mapped to those synchronization signals and/or beams to perform a RACH procedure to connect to the network entity.

One or more technical problems arise when indicating one or more PRACH adaptations of a PRACH configuration. For example, a network entity may send a PRACH adaptation indication to one or more devices that are currently within a coverage area of the network entity (e.g., one or more devices that are camped on a cell of the network entity), and the one or more devices may be expected to apply a PRACH adaptation based on receiving the PRACH adaptation indication. In some aspects, the PRACH adaptation indication may include a change in a periodicity of ROs (e.g., increasing or decreasing a corresponding number of ROs), a change in ROs mapped to synchronization signals and/or beams, muting one or more ROs, or another PRACH adaptation not expressly described herein. However, if one or more additional devices attempt to access or connect to the network entity after the PRACH adaptation indication is sent by the network entity, the one or more additional devices may not know that the PRACH adaptation has been applied to a corresponding PRACH configuration, and the one or more additional devices may not know that there are additional ROs available to be used and/or know to avoid using one or more muted ROs (e.g., ROs that are removed).

Accordingly, the techniques and signaling described herein may provide a technical solution for a network entity sending a message that includes a first PRACH configuration (e.g., a legacy PRACH configuration) and PRACH adaptation information, where the PRACH adaptation information at least includes an indication of an activation state for PRACH adaptation. For example, the indication of the activation state for PRACH adaptation may be a binary indication (e.g., ‘0’ or ‘1’) that indicates whether the PRACH adaptation information is activated or not. In some aspects, a ‘0’ for the binary indication may indicate one or more PRACH adaptations are deactivated and/or not activated (e.g., the PRACH adaptation information is not activated), and a ‘1’ for the binary indication may indicate the one or more PRACH adaptations are activated (e.g., the PRACH adaptation information is activated). Additionally or alternatively, a lack of the indication of the activation state for PRACH adaptation in the message may implicitly indicate to the device that the one or more PRACH adaptation parameters are deactivated.

As such, if the indication of the activation state for PRACH adaptation indicates activation of the one or more PRACH adaptations, devices may use corresponding PRACH adaptations (e.g., use additional ROs, avoid muted ROs, etc.) for performing RACH procedures to connect to the network entity. For example, devices attempting to connect to the network entity may monitor for and receive the message and may determine whether a PRACH adaptation has been activated, not activated, and/or deactivated from the indication of the activation state for PRACH adaptation to then perform RACH procedures accordingly.

In some aspects, the PRACH adaptation information may include the one or more PRACH adaptations (e.g., increased or reduced RO periodicity, increased or reduced number of ROs, adjusted ROs mapped to synchronization signals and/or beams, one or more muted ROs, etc.), and the indication of the activation state for PRACH adaptation may indicate whether the one or more PRACH adaptations have been activated, not activated, and/or deactivated. If more than one PRACH adaptation is included in the PRACH adaptation information (e.g., multiple PRACH adaptation parameters or multiple PRACH configurations), the network entity may indicate which PRACH adaptation is active (e.g., in the message or in an additional message).

In some aspects, the PRACH adaptation information may include a default PRACH configuration that may be different than the first PRACH configuration or a PRACH configuration that includes the one or more PRACH adaptations. Additionally, the device may assume the default PRACH configuration is an active PRACH configuration for performing RACH procedures, and the indication of the activation state for PRACH configuration may indicate whether the default PRACH configuration is activated or not. In some aspects, the default PRACH configuration may be a legacy PRACH configuration (e.g., a PRACH configuration that is configured for legacy devices, such as devices that are not configured for a current generation of wireless communications and that have less advanced circuitry and/or processing capabilities than devices configured for a current generation of wireless communications), the legacy PRACH configuration with one or more PRACH adaptations applied, or a separate PRACH configuration. In such aspects, the network entity may indicate a selection parameter (e.g., in the message or in an additional message) for a device to select from the legacy PRACH configuration, the legacy PRACH configuration with one or more PRACH adaptations applied, or the separate PRACH configuration for the default PRACH configuration.

In some aspects, the message that includes the PRACH adaptation information may be a message that devices are configured to monitor for and receive from a network entity when the devices are located in a coverage area or cell of the network entity. For example, the message may be a system information message (e.g., a system information block (SIB), such as a first system information block (SIB1) or another SIB) or a radio resource control (RRC) configuration message.

Typically, when the network entity modifies one or more parameters in a system information message, the network entity may send a paging message to devices in the coverage area and/or a cell of the network entity to indicate the modification, such as changing the indication of the activation state for PRACH adaptation. However, such signaling of the paging message may increase signaling overhead and expend power and/or energy at the network entity. As such, as described herein, the network entity may refrain from sending a paging message to the devices when changing the indication of the activation state for PRACH adaptation in the message. Additionally, the devices may assume that the indication of the activation state for PRACH adaptation is valid until an end of a modification period unless a paging message is received indicating a system information message has been modified (e.g., if content in the message is changed other than the indication of the activation state for PRACH adaptation). In some aspects, the network entity may send an indication of the modification period to the devices in the message or an additional message (e.g., an additional system information message, additional SIB, or an RRC configuration message).

In some aspects, while the above described techniques and signaling are described in reference to adapting a PRACH configuration, the techniques and signaling may be extended to adapting other signals and channels, such as paging messages, synchronization signals, etc. For example, the network entity may signal an indication of an activation state for adaptation of paging messages to indicate whether one or more parameters of paging occasions for paging message transmissions have been adapted, such as increasing or reducing a number of paging occasions, where the adaptation of the paging occasions may including confining the paging occasions in the time domain. Additionally, the adaptation of the paging occasions may not increase a paging latency. Additionally or alternatively, the network entity may signal an indication of an activation state for adaptation of synchronization signals to indicate whether one or more parameters of synchronization signal transmissions have been adapted, such as increasing or decreasing a periodicity and/or a number of synchronization signals.

The techniques for sending an indication of an activation state for PRACH adaptation and/or adaptation of other signals and channels as described herein may provide any of various beneficial technical effects and/or advantages. For example, the network entity may save energy by activating a PRACH adaptation (and/or activating an adaptation of other signals and channels) by sending the indication of the activation state rather than sending one or more downlink messages indicating the PRACH adaptation (and/or an adaptation of other signals and channels). As described previously, one or more devices may attempt to connect to the network entity, but the one or more devices may not have received a downlink message for a PRACH adaptation. Rather than the network entity sending another downlink message for the PRACH adaptation to the one or more devices, the network entity may save energy by indicating activation or deactivation of PRACH adaptation in a message that the one or more devices are configured to monitor (e.g., via the indication of the activation state for PRACH adaptation). Additionally, the network entity may save energy by refraining from sending a paging message to the devices when changing the indication of the activation state for PRACH adaptation.

Additionally, the network entity may save energy by dynamically adapting PRACH configurations and/or other signals and channels to reduce signaling overhead (e.g., reducing and/or muting ROs, reducing paging occasions, reducing synchronization signal transmissions, etc.). Additionally or alternatively, the network entity may increase reliability for communications by dynamically adapting PRACH configurations and/or other signals and channels to increase a likelihood that devices are able to successfully connect to the network entity (e.g., based on increasing a number of ROs, increasing a number of paging occasions, increasing a number of synchronization signal transmissions, etc.). In some aspects, the network entity may also save energy based on reducing a likelihood of having to perform retransmissions to the devices if the devices are unable to successfully connect. Additionally, the devices may reduce power consumption based on more accurately performing RACH procedures using the adapted PRACH configurations and/or other signals and channels (e.g., using additional ROs, avoiding muted ROs, monitoring additional paging occasions, monitoring for and receiving a higher number of synchronization signals, etc.).

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

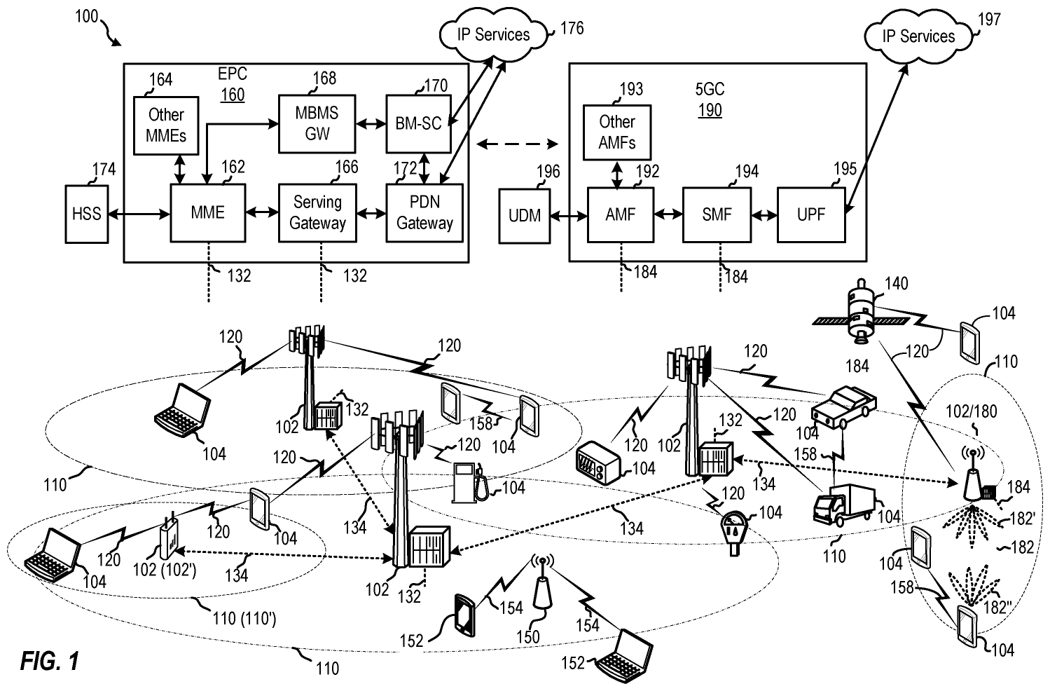

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects (also referred to herein as non-terrestrial network entities), such as ground-based network entities (e.g., BSs 102), and non-terrestrial aspects, such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

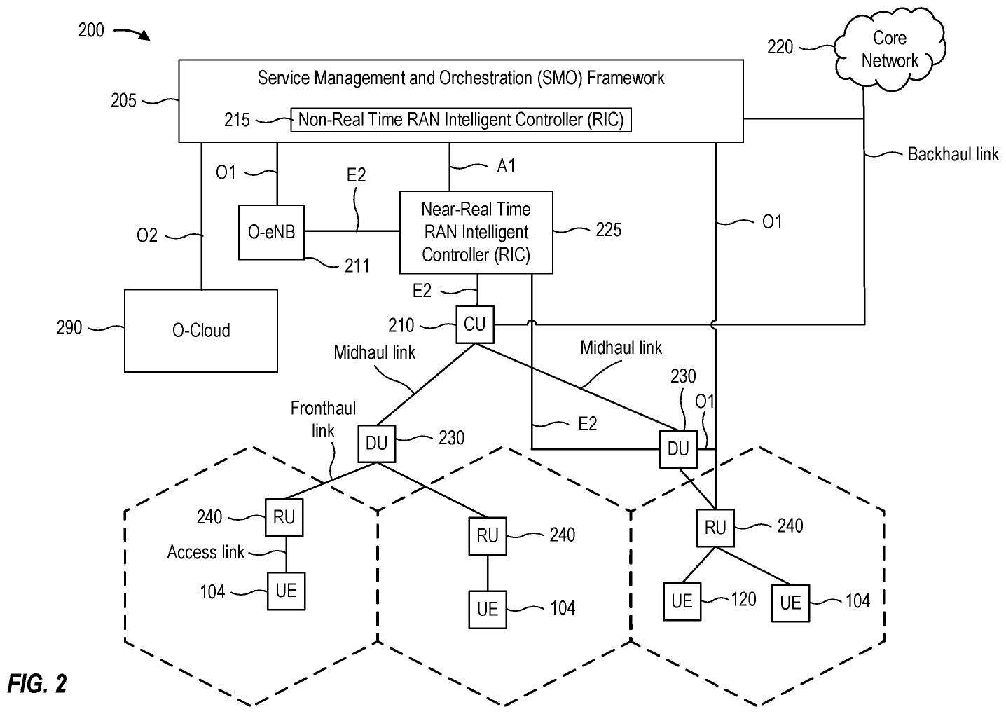

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

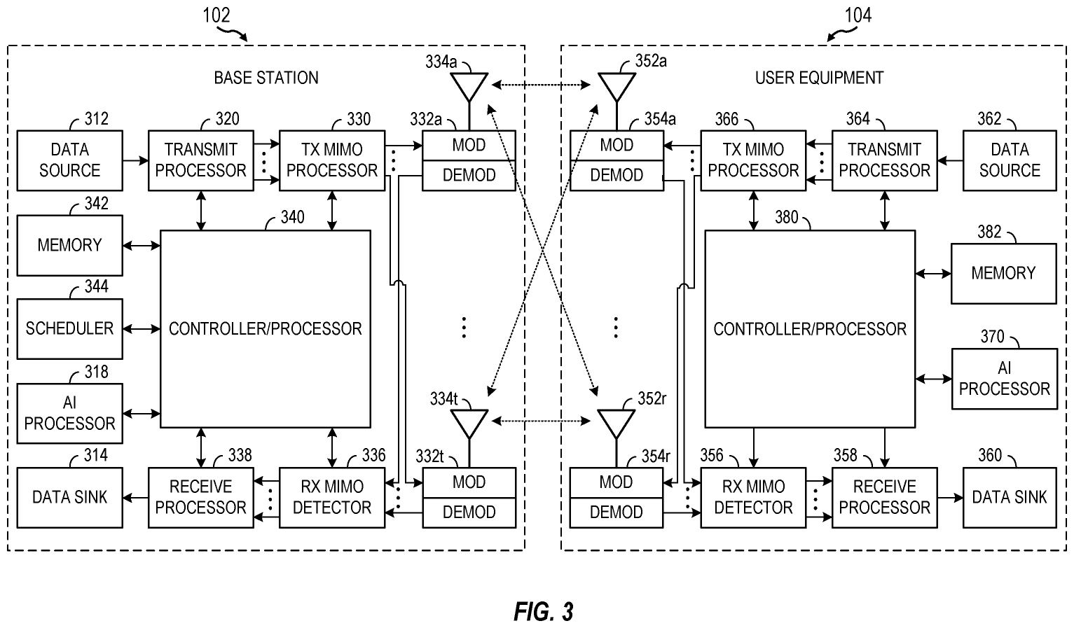

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

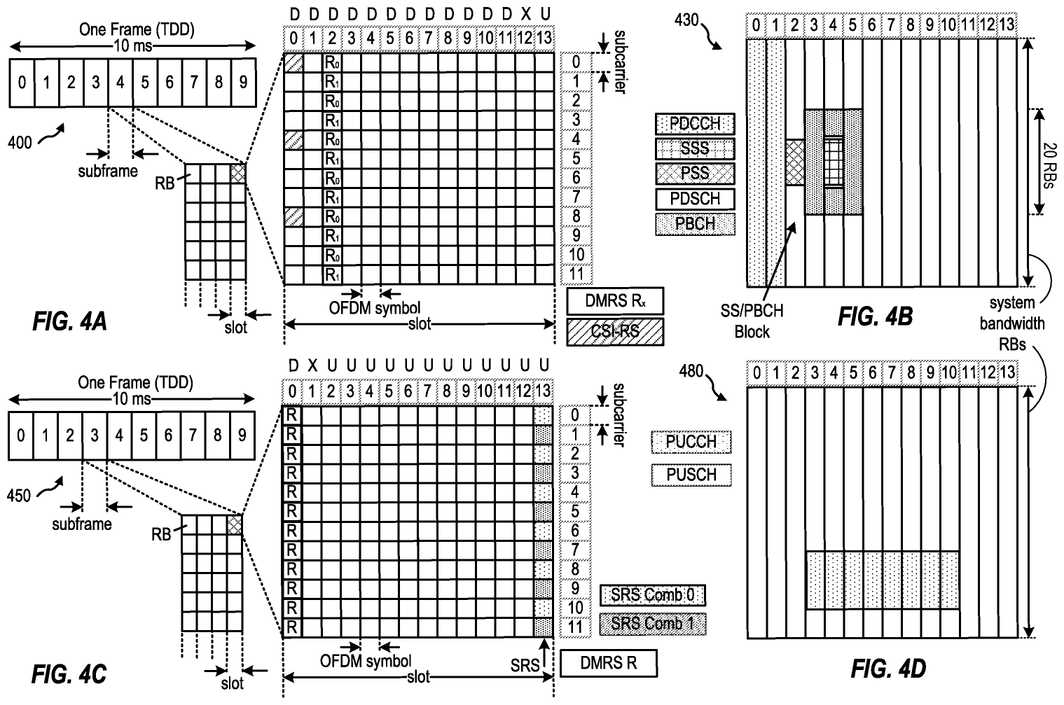

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Indicating an Activation State for PRACH Adaptation

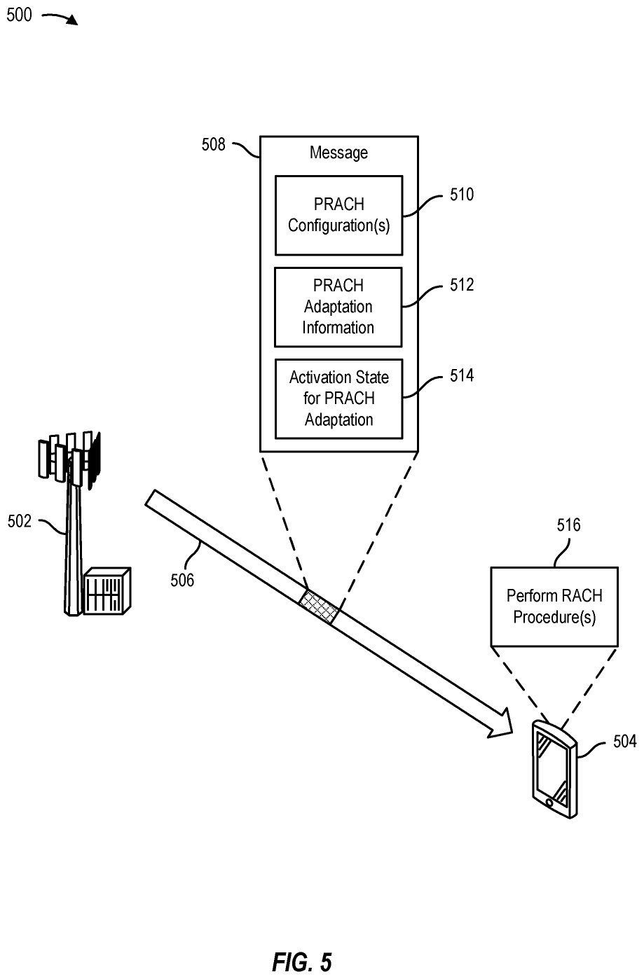

FIG. 5 depicts an example wireless communications system 500 for indicating an activation state for PRACH adaptation in accordance with aspects of the present disclosure. In some aspects, the wireless communications system 500 may implement aspects of or may be implemented by aspects of FIGS. 1-4D. For example, the wireless communications system 500 may include a network entity 502 and at least one device 504, where the network entity 502 may represent a base station or similar network entity as described with reference to FIGS. 1-3 and 13 (e.g., BS 102, BS 180, communications device 1300, etc.) and the device 504 may represent a UE or similar terminal device as described with reference to FIGS. 1-3 and 12 (e.g., UE 104, communications device 1200, etc.). Additionally, the network entity 502 and the device 504 may wirelessly communicate via a downlink communication link 506 (e.g., one or more carriers, a communication link 120, beamforming 182, etc.). While only one (1) device 504 is depicted in the example of FIG. 5, the network entity 502 may communicate with multiple devices.

In some aspects, the device 504 may perform a RACH procedure to request access to the network entity 502 to connect to the network entity 502 for a first time (e.g., initial access) or after a period of inactivity. The RACH procedure may be a two-step RACH procedure or a four-step RACH procedure.

In the four-step RACH procedure, the device 504 may select (e.g., for contention-based random access (CBRA)) or may be configured with (e.g., for contention-free random access (CFRA)) a RACH preamble from a group of available preambles (e.g., indicated by the network entity 502 in an SSB, SIB, or RRC configuration message) and may send a first RACH message (e.g., msg1) to the network entity 502 (e.g., via configured PRACH resources) that includes the RACH preamble. The network entity 502 may then send a second RACH message (e.g., msg2) to the device 504 within a RACH response window, where the second RACH message includes a RACH response and one or more parameters for subsequent communications (e.g., the RACH preamble to indicate the second RACH message is intended for the device 504, timing alignment information, an initial uplink grant, a cell radio network temporary identifier (C-RNTI, etc.). The device 504 may then send a third RACH message (e.g., msg3) that includes uplink scheduling information based on receiving the second RACH message. The network entity 502 may then send a fourth RACH message (e.g., msg4) to the device 504 before a contention resolution timer expires for contention resolution (e.g., if multiple devices select a same RACH preamble for the first RACH message). If the device 504 receives the fourth RACH message from the network entity 502, the device 504 may determine the four-step RACH procedure was successful, and the device 504 may enter a connected state with the network entity 502 for enabling subsequent communications.

In the two-step RACH procedure, the device 504 may send a first RACH message (e.g., msgA) that includes the contents of the first RACH message (e.g., msg1) and the third RACH message (e.g., msg3) as described above with reference to the four-step RACH procedure. The network entity 502 may then send a second RACH message (e.g., msgB) that includes the contents of the second RACH message (e.g., msg2) and the fourth RACH message (e.g., msg4) as described above with reference to the four-step RACH procedure. If the device 504 receives the second RACH message from the network entity 502, the device 504 may determine the two-step RACH procedure was successful, and the device 504 may enter a connected state with the network entity 502 for enabling subsequent communications.

In some aspects, prior to performing a RACH procedure (e.g., the four-step RACH procedure or the two-step RACH procedure), the network entity 502 may send a PRACH configuration to the network entity 502 (e.g., via a SIB, such as a SIB1; RRC configuration message; etc.). The PRACH configuration may include parameters for enabling the device 504 to perform the RACH procedure, such as RACH preambles for the device 504 to select from, an indication of ROs where the device 504 can perform the RACH procedure (e.g., time-frequency resources for performing the RACH procedure), a mapping of SSBs to the ROs, information for the RACH response window, information for the contention resolution timer, etc.

In some aspects, the PRACH configuration may be static (e.g., the parameters remain unchanged), or the network entity 502 may update one or more parameters in the PRACH configuration, which may result in the network entity 502 sending a paging message to devices that previously received the PRACH configuration to indicate to those devices that the PRACH configuration was updated. In the case where one or more parameters are updated, the network entity 502 may send the updated PRACH configuration after sending the paging message, and the devices may be expected to monitor for and receive the updated PRACH configuration. However, this updating of the PRACH configuration may increase signaling overhead for the device 504 (e.g., based on sending the paging message in addition to sending the updated PRACH configuration) and increase power consumption for the network entity 502 and the devices (e.g., based on configuring and signaling the paging message and the devices having to monitor for and receive the paging message).

Accordingly, PRACH adaptation may be used to update one or more parameters of the PRACH configuration without the network entity 502 having to send paging messages indicating for devices to monitor for and receive an updated PRACH configuration and/or having to send the updated PRACH configuration. For example, the network entity 502 may indicate the PRACH adaptation based on dynamic adaptation by sending one or more downlink messages to one or more devices, such as permanent equipment identifier (PEI) signaling, a DCI message (e.g., paging DCI), paging payload, a medium access control (MAC) control element (CE), RRC signaling, or another type of message not expressly listed herein. As described previously, the PRACH adaptation may include increasing or decreasing a number of ROs, increasing or decreasing a periodicity of the ROs, adjusting one or more ROs mapped to SSBs and/or beams, muting one or more ROs, etc. Additionally, the network entity 502 may determine to update the one or more parameters of the PRACH configuration based on an identified need (e.g., the number of ROs are over-provisioned or under-provisioned based on fewer or more devices being in a coverage area of the network entity, an increase or decrease in downlink traffic and/or expected uplink traffic, etc.).

In some aspects, the network entity 502 may send an indication of the PRACH adaptation to one or more devices that are currently within a coverage area of the network entity (e.g., one or more devices that are camped on a cell of the network entity 502), and the one or more devices may be expected to apply the PRACH adaptation based on receiving the indication. However, if one or more additional devices attempt to access or connect to the network entity 502 after the PRACH adaptation indication is sent by the network entity, the one or more additional devices may not know that the PRACH adaptation has been applied to a corresponding PRACH configuration, and the one or more additional devices may not know that there are additional ROs available to be used and/or know to avoid using one or more muted ROs (e.g., ROs that are removed) to perform a RACH procedure.

As described herein, the network entity 502 may send a message 508 that includes one or more PRACH configurations 510, PRACH adaptation information 512, and an indication 514 of an activation state for PRACH adaptation. Accordingly, the indication 514 of the activation state for PRACH adaptation may indicate whether the PRACH adaptation information 512 is activated or not. For example, the indication 514 may be a binary indication (e.g., ‘0’ or ‘1’) that indicates whether the PRACH adaptation information 512 is activated or not. In some aspects, a ‘0’ for the binary indication may indicate one or more PRACH adaptations are not activated and/or deactivated (e.g., the PRACH adaptation information 512 is not activated and/or deactivated), and a ‘1’ for the binary indication may indicate the one or more PRACH adaptations are activated (e.g., the PRACH adaptation information 512 is activated). Additionally or alternatively, a lack of the indication 514 of the activation state for PRACH adaptation in the message 508 may implicitly indicate to the device 504 that the one or more PRACH adaptation parameters are deactivated.

As such, if the indication 514 of the activation state for PRACH adaptation indicates activation of the one or more PRACH adaptations, the device 504 may use corresponding PRACH adaptations (e.g., use additional ROs, avoid muted ROs, etc.) for performing one or more RACH procedures 516 to connect to the network entity 502. In some aspects, the indication 514 of the activation state for PRACH adaptation may be an information element defined to indicate the activation state.

In some aspects, the PRACH adaptation information 512 may include at least a different number of ROs (e.g., one or more extra ROs or one or more muted ROs) than a legacy PRACH configuration (e.g., indicated in the one or more PRACH configurations 510 and/or previously configured by the network entity 502), where the legacy PRACH configuration may be a PRACH configuration that is configured for legacy devices (e.g., devices that are not configured for a current generation of wireless communications and that have less advanced circuitry and/or processing capabilities than devices configured for a current generation of wireless communications) but can be used by both the legacy devices and more advanced devices.

In some aspects, the PRACH adaptation information 512 may include a separate PRACH configuration (e.g., different than the legacy PRACH configuration) that the device 504 uses for RACH procedures when the indication 514 of the activation state for PRACH adaptation indicates activation of PRACH adaptation to perform the RACH procedure(s) 516. Additionally or alternatively, the PRACH adaptation information 512 may include the separate PRACH configuration, and the device 504 may apply a union between the separate PRACH configuration and the legacy PRACH configuration to determine a PRACH configuration that includes parameters from both the separate PRACH configuration and the legacy PRACH configuration. Subsequently, the device 504 may perform the RACH procedure(s) 516 using the determined PRACH configuration when the indication 514 of the activation state for PRACH adaptation indicates activation of PRACH adaptation. Additionally or alternatively, the PRACH adaptation information 512 may include one or more PRACH adaptation parameters (e.g., an RO periodicity, a number of ROs, a number of SSBs mapped to the ROs, etc.) that the device 504 activates and/or applies when the indication 514 of the activation state for PRACH adaptation indicates activation of PRACH adaptation to perform the RACH procedure(s) 516.

Additionally or alternatively, the PRACH adaptation information 512 may include a muting pattern indicating one or more ROs of the legacy PRACH configuration that are muted (e.g., not available to be used for RACH procedures) that the device 504 activates and/or applies when the indication 514 of the activation state for PRACH adaptation indicates activation of PRACH adaptation to perform the RACH procedure(s) 516. In some aspects, the muting pattern may be indicated via a bitmap in the PRACH adaptation information 512 that indicates the one or more muted ROs. For example, the bitmap may include a plurality of index values (e.g., bit strings), where each index value corresponds to different configurations of which ROs are muted.

In some aspects, the PRACH adaptation information 512 may include multiple PRACH adaptation configurations, and the network entity 502 may indicate (e.g., in the indication 514 of the activation state for PRACH adaptation or in another indication of the message 508) which PRACH adaptation configuration(s) are active or if none of the PRACH configurations are active. For example, rather than the indication 514 of the activation state for PRACH adaptation being a binary indication, the indication 514 may include multiple bits to indicate if the activation state for PRACH adaptation is the inactive state and none of the PRACH configurations are active (e.g., ‘00’, ‘000’, ‘0000’, etc.) or the active state and which PRACH adaptation configuration(s) are active (e.g., ‘10’, ‘011’, ‘0101’, etc.). Additionally or alternatively, the indication 514 of the activation state for PRACH adaptation may include the binary indication as described previously and an additional indication to indicate which PRACH adaptation configuration(s) are active. In some aspects, the multiple PRACH adaptation configurations may include one or more separate PRACH configurations, one or more PRACH adaptation parameters, the muting pattern, or a combination thereof. In some aspects, the indication 514 of the activation state for PRACH adaptation may be an information element defined to indicate the activation state, which PRACH adaptation configuration(s) are active, or both.

In some aspects, the device 504 may assume a default PRACH configuration is an active PRACH configuration for performing the RACH procedure(s) 516. For example, the default PRACH configuration may be the legacy PRACH configuration, the legacy PRACH configuration with the PRACH adaptation information 512 applied, or an independent PRACH configuration. Accordingly, the network entity 502 may indicate a selection parameter (e.g., in the message 508 or in an additional message, such as an additional system information message, SIB, or RRC configuration message) to indicate whether the default PRACH configuration is the legacy PRACH configuration, the legacy PRACH configuration with the PRACH adaptation information 512 applied, or the independent PRACH configuration. In some aspects, the network entity 502 may indicate the default PRACH configuration in the one or more PRACH configurations 510 of the message 508. Additionally or alternatively, the network entity 502 may indicate the default PRACH configuration in an additional message (e.g., additional system information message, SIB, or RRC configuration message). In some aspects, the device 504 may use the default PRACH configuration for a RACH procedure 516 for initial access with the network entity 502.

In some aspects, the network entity 502 may refrain from sending a paging message to the device 504 when changing the indication 514 of the activation state for PRACH adaptation in the message 508. Additionally, the device 504 may assume that the indication 514 of the activation state for PRACH adaptation is valid until an end of a modification period unless a paging message is received indicating the message 508 has been modified (e.g., if content in the message 508 is changed other than the indication 514 of the activation state for PRACH adaptation). In some aspects, the network entity 502 may send an indication of the modification period to the device 504 in the message 508 or an additional message (e.g., an additional system information message, additional SIB, or an RRC configuration message).

In some aspects, as described previously, while the above described techniques and signaling are described in reference to adapting a PRACH configuration, those techniques and signaling may likewise be extended to adapting other signals and channels, such as paging messages, synchronization signals (e.g., SSBs), etc.

### Example PRACH Adaptations

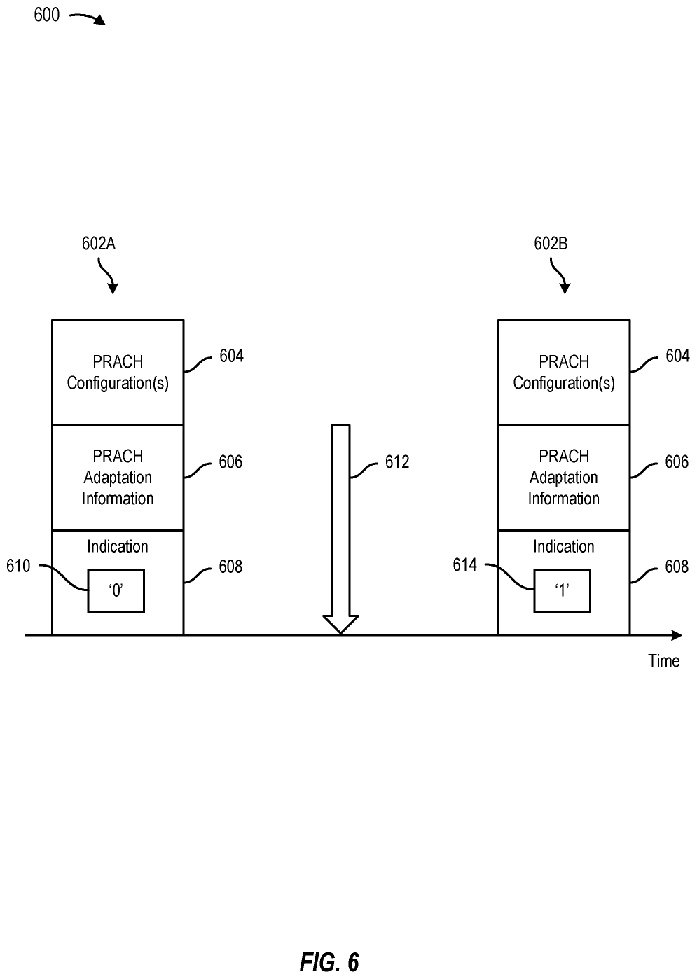

FIG. 6 depicts an example signaling 600 of indication of an adaptation for a PRACH configuration in accordance with aspects of the present disclosure. In some aspects, the signaling 600 may implement aspects of or may be implemented by aspects of FIGS. 1-5 and 12-13. For example, a network entity (e.g., BS 102, BS 180, network entity 502, communications device 1300, etc.) may use the signaling 600 to indicate an adaptation for a PRACH configuration to a device (e.g., UE 104, device 504, communications device 1200, etc.) as described with reference to FIG. 5.

In some aspects, the network entity may send one or more messages 602 to the device, where the one or more messages 602 may correspond to the message 508 as described with reference to FIG. 5. For example, the one or more messages 602 may include one or more PRACH configurations 604 (e.g., corresponding to the one or more PRACH configurations 510 as described with reference to FIG. 5), PRACH adaptation information 606 (e.g., corresponding to the PRACH adaptation information 512 as described with reference to FIG. 5), and an indication 608 of an activation state for PRACH adaptation (e.g., corresponding to the indication 514 of an activation state for PRACH adaptation as described with reference to FIG. 5).

In the example of FIG. 6, the network entity may send a first message 602A, where the first message 602A includes a deactivation indication 610 or indication to not activate the PRACH adaptation (e.g., ‘0’) for the indication 608 of the activation state for PRACH adaptation that indicates PRACH adaptation is not activated and/or deactivated. In some aspects, the device may perform one or more RACH procedures using a default PRACH configuration (e.g., as described with reference to FIG. 5) or a legacy PRACH configuration based on the deactivation indication 610. In some aspects, the network entity may send an adaptation indication 612 (e.g., PRACH adaptation indication) that includes one or more PRACH adaptations (e.g., increasing or decreasing a number of ROs, increasing or decreasing a periodicity of the ROs, adjusting one or more ROs mapped to SSBs and/or beams, muting one or more ROs, etc.) to one or more devices that are currently within a coverage area of the network entity (e.g., one or more devices that are camped on a cell of the network entity). Accordingly, the one or more devices may then apply the one or more PRACH adaptations for performing subsequent RACH procedures based on receiving the adaptation indication 612. In some aspects, the network entity may send the adaptation indication 612 via PEI signaling, a DCI message (e.g., paging DCI), paging payload (e.g., a payload of a paging message), MAC-CE, RRC signaling, or another type of message not expressly listed herein.

However, as described previously, any devices that attempt to access or connect to the network entity after the adaptation indication 612 is sent by the network entity may not know that the one or more PRACH adaptations (e.g., indicated by the adaptation indication 612) have been applied to a corresponding PRACH configuration. As such, the devices that attempt to access or connect to the network entity after the adaptation indication 612 may be limited to using a legacy PRACH configuration or a default PRACH configuration when performing one or more RACH procedures, as described with reference to FIG. 5, but the legacy PRACH configuration or default PRACH configuration may include, as an example, fewer ROs and/or one or more ROs that have been muted based on the one or more PRACH adaptations from the adaptation indication 612, which may decrease a likelihood that the one or more RACH procedures will be successful.

Accordingly, as described herein, the network entity may send a second message 602B that includes the one or more PRACH configurations 604, the PRACH adaptation information 606, and the indication 608 of the activation state for PRACH adaptation. Rather than the indication 608 of the activation state for PRACH adaptation including the deactivation indication 610 that indicates PRACH adaptation is not activated and/or deactivated as in the first message 602A, the second message 602B may include an activation indication 614 (e.g., ‘1’) for the indication 608 of the activation state for PRACH adaptation, indicating that PRACH adaptation is activated, such as the one or more PRACH adaptations indicated by the adaptation indication 612 being activated. In some aspects, the activation indication 614 may indicate the one or more PRACH adaptations that are activated from the PRACH adaptation information 606. In some aspects, while the network entity is described sending the adaptation indication 612 prior to sending the second message 602B that includes the activation indication 614, the network entity may send the second message 602B including the activation indication 614 to indicate the PRACH adaptation information 606 is activated without sending the indication 612 (e.g., the second message 602B activates the one or more PRACH adaptations without a separate adaptation activation, such as the adaptation indication 612).

In some aspects, as described with reference to FIG. 5, the network entity may refrain from sending a paging message to devices when changing the indication 608 of the activation state for PRACH adaptation in the messages 602. Accordingly, in the example of FIG. 6, the network entity may refrain from sending a paging message prior to sending the second message 602B even though the second message 602B includes an updated component with respect to the first message 602A (e.g., the deactivation indication 610 in the first message 602A is changed to the activation indication 614 in the second message 602B).

Additionally, devices may not expect to receive a paging message from the network entity if the indication 608 of the activation state for PRACH adaptation is changed. In some aspects, the devices may assume that the indication 608 of the activation state for PRACH adaptation is valid until an end of a modification period (e.g., indicated by the network entity as described previously) unless a paging message is received indicating a message 602 has been modified (e.g., if content in a message 602 is changed other than the indication 608 of the activation state for PRACH adaptation, such as the one or more PRACH configurations 604 or the PRACH adaptation information 606). For example, devices that receive the first message 602A may assume the deactivation indication 610 for the PRACH adaptation remains valid until the end of the modification period, but the devices may still apply the one or more PRACH adaptations indicated in the adaptation indication 612 if the adaptation indication 612 is received. Additionally or alternatively, devices that receive the second message 602B may assume the activation indication 614 for the PRACH adaptation remains valid until the end of the modification period.

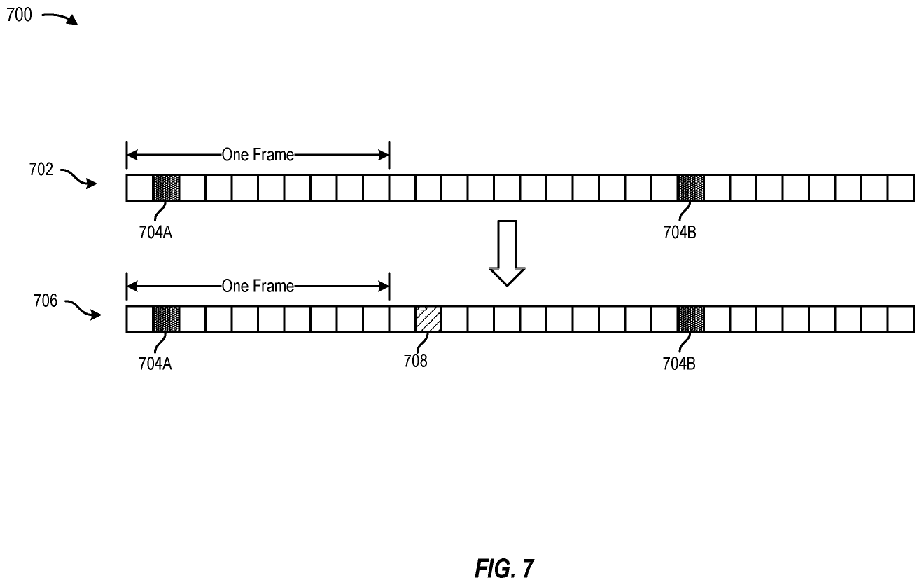

FIG. 7 depicts an example adaptation 700 for a PRACH configuration in accordance with aspects of the present disclosure. In some aspects, the adaptation 700 for a PRACH configuration may implement aspects of or may be implemented by aspects of FIGS. 1-6 and 12-13. For example, the adaptation 700 may represent a PRACH adaptation as described with reference to FIGS. 5 and 6, where a network entity (e.g., BS 102, BS 180, network entity 502, communications device 1300, etc.) may indicate (e.g., via an indication 514 or indication 608 of an activation state for PRACH adaptation as described with reference to FIGS. 5 and 6) the PRACH adaptation to one or more devices (e.g., UE 104, device 504, communications device 1200, etc.).

In the example of FIG. 7, a first PRACH configuration 702 may include one or more ROs 704 with a first periodicity. In some aspects, the first PRACH configuration 702 may include at least a first RO 704A and a second RO 704B, where the first RO 704A and the second RO 704B are separated in the time-domain according to the first periodicity. For example, as shown in the example of FIG. 7, the first periodicity may be 20 ms, and the first RO 704A and the second RO 704B may be separated by 20 ms (e.g., 20 subframes, where each subframe has a duration of 1 ms, and one frame includes 10 subframes). In some aspects, the first PRACH configuration 702 may be a legacy PRACH configuration or a default PRACH configuration as described with reference to FIG. 5.

Subsequently, the network entity may indicate, to the one or more devices, one or more PRACH adaptations are activated (e.g., the one or more adaptations are applied to the first PRACH configuration 702), and the one or more devices may determine and/or use a second PRACH configuration 706 to perform RACH procedures, where the second PRACH configuration 706 includes the one or more activated PRACH adaptations. For example, the one or more PRACH adaptations may include a second periodicity for the second PRACH configuration 706, where the second periodicity is different than the first periodicity configured for the first PRACH configuration 702.

Based on the second periodicity, the second PRACH configuration 706 may include at least one additional RO, such as an additional RO 708, compared to the first PRACH configuration 702. In the example of FIG. 7, the second periodicity configured for the second PRACH configuration 706 may be 10 ms, such that the first RO 704A and the additional RO 708 are separated by 10 ms (e.g., 10 subframes) and the additional RO 708 and the second RO 704B are also separated by 10 ms.

### Example Operations of Entities in a Communications Network for Indicating an Activation State for PRACH Adaptation

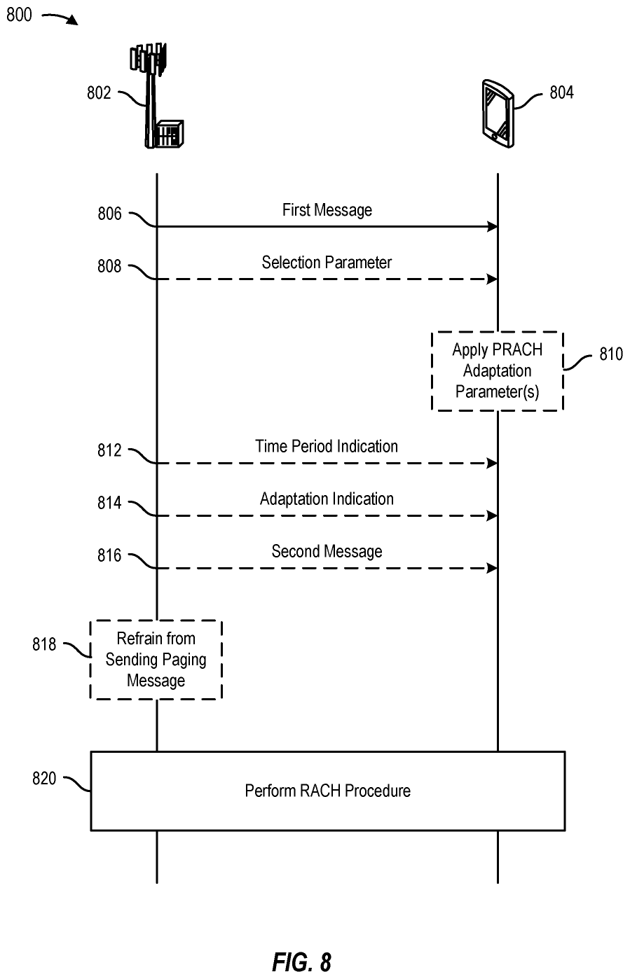

FIG. 8 depicts a process flow 800 for communications in a network between a network entity and a device with an indication of an activation state for PRACH adaptation in accordance with aspects of the present disclosure. In some aspects, the process flow 800 may implement aspects of or may be implemented by aspects of FIGS. 1-7. For example, the process flow 800 may include a network entity 802 and at least one device 804, where the network entity 802 may represent a base station or similar network entity as described with reference to FIGS. 1-3, 5-7, and 13 (e.g., BS 102, BS 180, network entity 502, communications device 1300, etc.) and the device 804 may represent a UE or similar terminal device as described with reference to FIGS. 1-3, 5-7, and 12 (e.g., UE 104, device 504, communications device 1200, etc.).

In the following description of the process flow 800, the operations between the network entity 802 and the device 804 may be performed in different orders or at different times. Certain operations may also be left out of the process flow 800, or other operations may be added to the process flow 800. It is to be understood that while the network entity 802 and the device 804 are shown performing a number of the operations of the process flow 800, any wireless device may perform the operations shown.

At 806, the device 804 may receive, from the network entity 802, a first message that includes PRACH adaptation information. For example, the first message may be a system information message (e.g., SIB, SIB1, etc.) or an RRC configuration message. In some aspects, the PRACH adaptation information may include a first PRACH configuration and an indication of an activation state for PRACH adaptation, where the indication of the activation state for PRACH adaptation indicates activation or deactivation of one or more PRACH adaptations. Additionally or alternatively, the PRACH adaptation information may include a plurality of PRACH adaptation configurations and an indication of an active PRACH adaptation configuration of the plurality of PRACH adaptation configurations. In some aspects, the PRACH adaptation information may include one or more additional PRACH configurations. Additionally or alternatively, the PRACH information may include one or more PRACH adaptation parameters for the first PRACH configuration.

At 808, the device 804 may receive, from the network entity 802, a selection parameter indicating for the device 804 to perform the RACH procedure using the first PRACH configuration, the first PRACH configuration with one or more PRACH adaptations applied, or an additional PRACH configuration included in the PRACH adaptation information based on the indication of the activation state for PRACH adaptation. Additionally or alternatively, if the PRACH adaptation information includes one or more additional PRACH configurations, the device 804 may receive, from the network entity 802, a selection parameter indicating a PRACH configuration of the one or more additional PRACH configurations that is activated or not based on the indication of the activation state for PRACH adaptation.

At 810, if the PRACH information includes the one or more PRACH adaptation parameters for the first PRACH configuration, the device 804 may apply the one or more PRACH adaptation parameters to the first PRACH configuration based on the indication of the activation state for PRACH adaptation. In some aspects, the first PRACH configuration may include a plurality of occasions for performing a RACH procedure, and the one or more PRACH adaptation parameters may include a periodicity of the plurality of occasions, a number of occasions configured for the plurality of occasions, a number of synchronization blocks configured per occasion of the plurality of occasions, a bitmap indicating one or more occasions of the plurality of occasions that are not to be used for RACH procedures, or a combination thereof.

At 812, the device 804 may receive, from the network entity 802, an additional message that includes an indication of a time period for which the indication of the activation state for PRACH adaptation is valid. In some aspects, the device 804 may receive, from the network entity 802, a system information update message indicating one or more updates have been made to the first message, and the time period may be shortened based on receiving the system information update message.

At 814, the device 804 may receive, from the network entity 802, an indication of an adaptation to the first PRACH configuration after receiving the first message, and the device 804 may apply the adaptation to the first PRACH configuration based on receiving the indication of the adaptation. In some aspects, the indication of the activation state for PRACH adaptation in the first message may include an indication that PRACH adaptation is not activated and/or deactivated prior to the indication of the adaptation being sent. In some aspects, the device 804 may receive the indication of the adaptation via one or more of: a DCI message, a MAC-CE, and an RRC configuration message.

At 816, the device 804 may receive, from the network entity 802, a second message that includes the PRACH adaptation information, where the indication of the activation state for PRACH adaptation in the second message includes an indication that PRACH adaptation is activated.

At 818, the network entity 802 may refrain from sending a paging message when the indication of the activation state for PRACH adaptation is changed. Additionally or alternatively, the device 804 may not expect to receive a paging message when the indication of the activation state for PRACH adaptation is changed.

At 820, the device 804 and the network entity 802 may perform a RACH procedure based on the PRACH adaptation information. In some aspects, if the PRACH adaptation information includes one or more additional PRACH configurations, the device 804 may perform the RACH procedure using a PRACH configuration of the one or more additional PRACH configurations based on the indication of the activation state for PRACH adaptation. In some aspects, the PRACH adaptation information may include a default PRACH configuration. Accordingly, the device 804 may perform a RACH procedure using the default PRACH configuration for an initial access procedure, based on the indication for the activation state for PRACH adaptation, or a combination thereof.

### Example Operations of a User Equipment

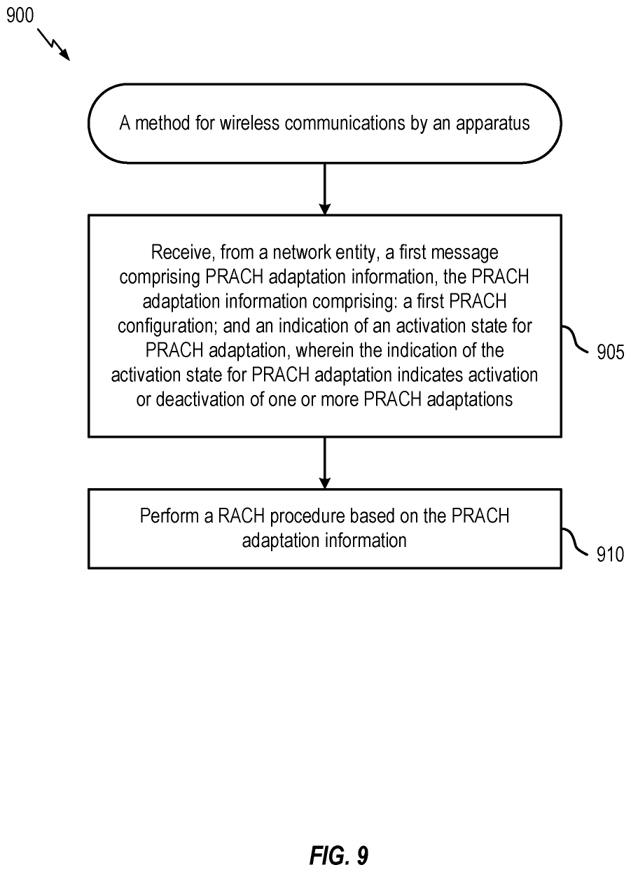

FIG. 9 shows a method 900 for wireless communications by an apparatus, such as UE 104 of FIGS. 1 and 3.

Method 900 begins at block 905 with receiving, from a network entity, a first message comprising PRACH adaptation information, the PRACH adaptation information comprising: a first PRACH configuration; and an indication of an activation state for PRACH adaptation, wherein the indication of the activation state for PRACH adaptation indicates activation or deactivation of one or more PRACH adaptations.

Method 900 then proceeds to block 910 with performing a RACH procedure based on the PRACH adaptation information.

In certain aspects, the PRACH adaptation information further comprises: a plurality of PRACH adaptation configurations; and an indication of an active PRACH adaptation configuration of the plurality of PRACH adaptation configurations.

In certain aspects, the PRACH adaptation information further comprises one or more additional PRACH configurations; and the method 900 further comprises performing the RACH procedure using a PRACH configuration of the one or more additional PRACH configurations based at least in part on the indication of the activation state for PRACH adaptation.

In certain aspects, method 900 further includes receiving, from the network entity, a selection parameter indicating the PRACH configuration of the one or more additional PRACH configurations.

In certain aspects, the PRACH adaptation information further comprises one or more PRACH adaptation parameters for the first PRACH configuration; and the method 900 further comprises applying the one or more PRACH adaptation parameters to the first PRACH configuration based at least in part on the indication of the activation state for PRACH adaptation.

In certain aspects, the first PRACH configuration comprises a plurality of occasions for performing the RACH procedure; and the one or more PRACH adaptation parameters comprise a periodicity of the plurality of occasions, a number of occasions configured for the plurality of occasions, a number of synchronization blocks configured per occasion of the plurality of occasions, a bitmap indicating one or more occasions of the plurality of occasions that are not to be used for RACH procedures, or a combination thereof.

In certain aspects, method 900 further includes receiving, from the network entity, an additional message comprising an indication of a time period for which the indication of the activation state for PRACH adaptation is valid.

In certain aspects, method 900 further includes receiving, from the network entity, a system information update message indicating one or more updates have been made to a system information message, wherein the time period is shortened based at least in part on receiving the system information update message.

In certain aspects, the PRACH adaptation information further comprises a default PRACH configuration.

In certain aspects, method 900 further includes performing the RACH procedure using the default PRACH configuration based on performing an initial access procedure, based on the indication for the activation state for PRACH adaptation, or a combination thereof.

In certain aspects, method 900 further includes receiving, from the network entity, a selection parameter indicating for the apparatus to perform the RACH procedure using the first PRACH configuration, the first PRACH configuration with the one or more PRACH adaptations applied, or an additional PRACH configuration included in the PRACH adaptation information.

In certain aspects, the indication of the activation state for PRACH adaptation in the first message indicates deactivation of the one or more PRACH adaptations; and the method 900 further comprises: receiving, from the network entity, an indication of an adaptation to the first PRACH configuration after receiving the message; applying the adaptation to the first PRACH configuration based at least in part on receiving the indication; and receiving, from the network entity, a second message comprising the PRACH adaptation information, wherein the indication of the activation state for PRACH adaptation in the second message indicates activation of the one or more PRACH adaptations.

In certain aspects, method 900 further includes receiving the indication of the adaptation via one or more of: a DCI message, a MAC-CE, and a RRC configuration message.

In certain aspects, method 900 further includes not expecting to receive a paging message if the indication of the activation state for PRACH adaptation is changed.

In certain aspects, the message comprises one or more of: a system information message and a RRC configuration message.

In certain aspects, method 900 may be performed by the apparatus to realize one or more technical effects or solutions to the aforementioned technical problem(s). For example, based on method 900, the apparatus may reduce power consumption based on more accurately performing RACH procedures using adapted PRACH configurations and/or other signals and channels (e.g., using additional ROs, avoiding muted ROs, monitoring additional paging occasions, monitoring for and receiving a higher number of synchronization signals, etc.). Additionally, based on the method 900, the apparatus may increase communication reliability by using the adapted PRACH configuration(s) for performing RACH procedures, where the adapted RACH configuration(s) are more optimized or efficient for the apparatus to perform the RACH procedures, thereby increasing a likelihood the RACH procedures are successful.

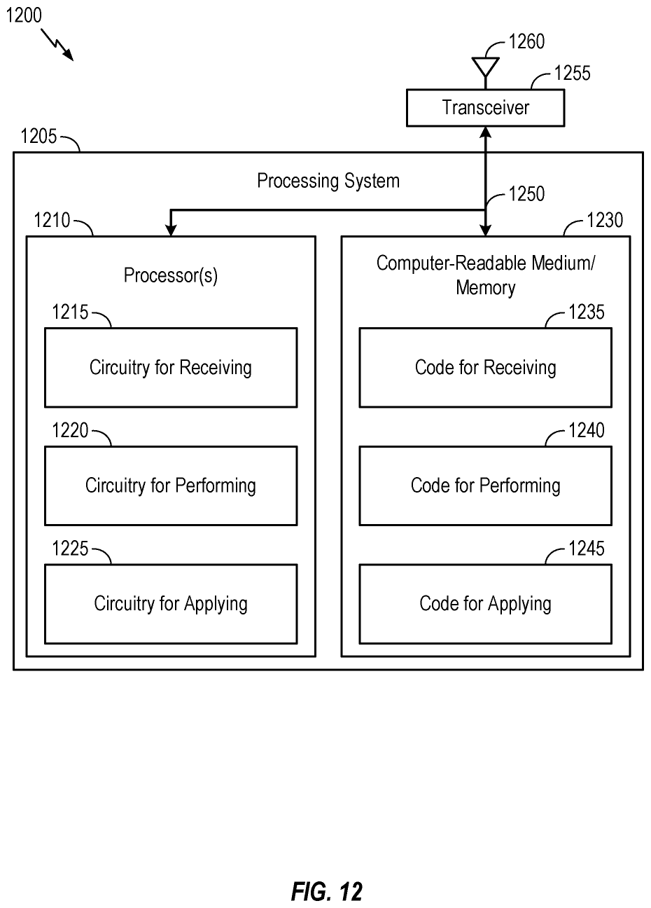

In certain aspects, method 900, or any aspect related to it, may be performed by an apparatus, such as communications device 1200 of FIG. 12, which includes various components operable, configured, or adapted to perform the method 900. Communications device 1200 is described below in further detail.

Note that FIG. 9 is just one example of a method, and other methods including fewer, additional, or alternative operations are possible consistent with this disclosure.

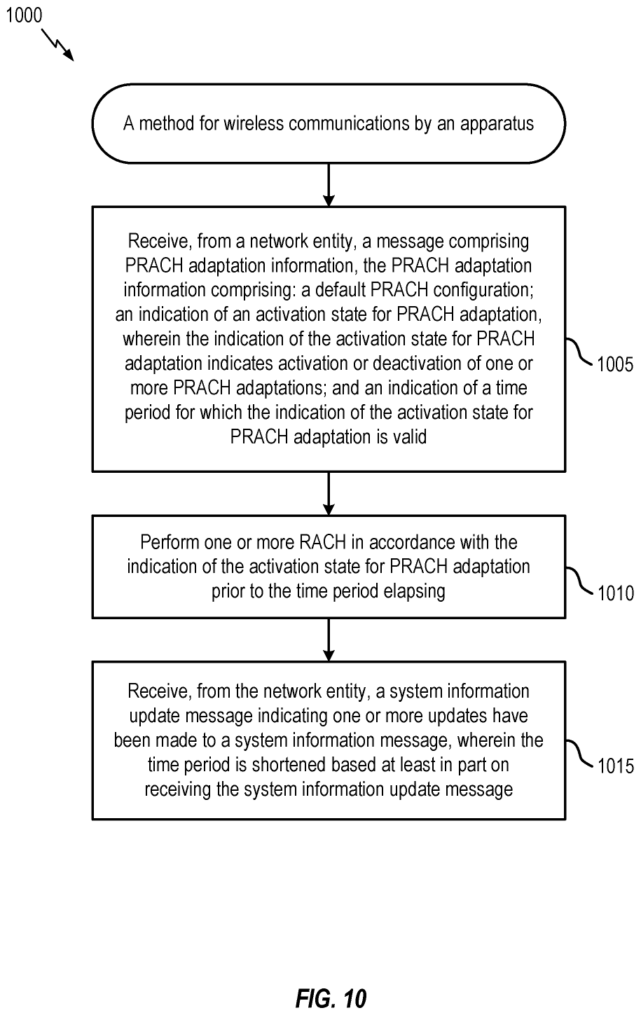

FIG. 10 shows a method 1000 for wireless communications by an apparatus, such as UE 104 of FIGS. 1 and 3.

Method 1000 begins at block 1005 with receiving, from the network entity, a message comprising PRACH adaptation information, the PRACH adaptation information comprising: a default PRACH configuration; an indication of an activation state for PRACH adaptation, wherein the indication of the activation state for PRACH adaptation indicates activation or deactivation of one or more PRACH adaptations; and an indication of a time period for which the indication of the activation state for PRACH adaptation is valid.

Method 1000 then proceeds to block 1010 with performing one or more RACH in accordance with the indication of the activation state for PRACH adaptation prior to the time period elapsing.

Method 1000 then proceeds to block 1015 with receiving, from the network entity, a system information update message indicating one or more updates have been made to a system information message, wherein the time period is shortened based at least in part on receiving the system information update message.

In certain aspects, method 1000 may be performed by the apparatus to realize one or more technical effects or solutions to the aforementioned technical problem(s). For example, based on method 1000, the apparatus may save energy by not expecting to receive a paging message from the network entity when the network entity changes the indication of the activation state for PRACH adaptation, thereby reducing processing power by not having to monitor for, receive, and decode the paging message.

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Network Entity

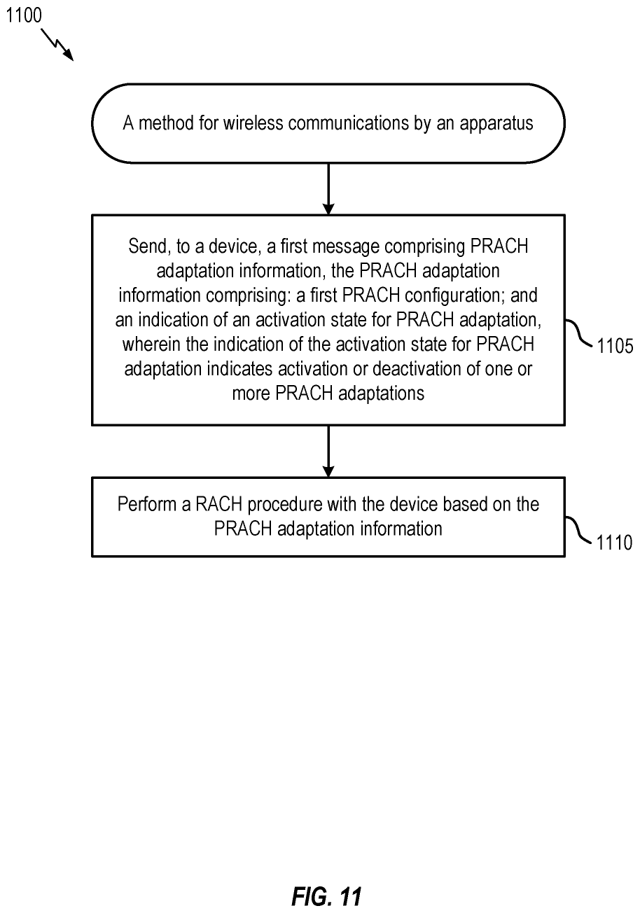

FIG. 11 shows a method 1100 for wireless communications by an apparatus, such as BS 102 of FIGS. 1 and 3, or a disaggregated base station as discussed with respect to FIG. 2.

Method 1100 begins at block 1105 with sending, to a device, a first message comprising PRACH adaptation information, the PRACH adaptation information comprising: a first PRACH configuration; and an indication of an activation state for PRACH adaptation, wherein the indication of the activation state for PRACH adaptation indicates activation or deactivation of one or more PRACH adaptations.

Method 1100 then proceeds to block 1110 with performing a RACH procedure with the device based on the PRACH adaptation information.

In certain aspects, the PRACH adaptation information further comprises: a plurality of PRACH adaptation configurations; and an indication of an active PRACH adaptation configuration of the plurality of PRACH adaptation configurations.

In certain aspects, the PRACH adaptation information further comprises one or more additional PRACH configurations; and the method 1100 further comprises sending the indication of the activation state for PRACH adaptation to indicate for the device to perform the RACH procedure using a PRACH configuration of the one or more additional PRACH configurations.

In certain aspects, method 1100 further includes sending, to the device, a selection parameter indicating the PRACH configuration of the one or more additional PRACH configurations.

In certain aspects, the PRACH adaptation information further comprises one or more PRACH adaptation parameters for the first PRACH configuration; and the method 1100 further comprises sending the indication of the activation state for PRACH adaptation to indicate for the device to apply the one or more PRACH adaptation parameters to the first PRACH configuration.

In certain aspects, the first PRACH configuration comprises a plurality of occasions for performing the RACH procedure; and the one or more PRACH adaptation parameters comprise a periodicity of the plurality of occasions, a number of occasions configured for the plurality of occasions, a number of synchronization blocks configured per occasion of the plurality of occasions, a bitmap indicating one or more occasions of the plurality of occasions that are not to be used for RACH procedures, or a combination thereof.

In certain aspects, method 1100 further includes sending, to the device, an additional message comprising an indication of a time period for which the indication of the activation state for PRACH adaptation is valid.

In certain aspects, method 1100 further includes sending, to the device, a system information update message indicating one or more updates have been made to a system information message, wherein the time period is shortened based at least in part on sending the system information update message.

In certain aspects, the PRACH adaptation information further comprises a default PRACH configuration.

In certain aspects, method 1100 further includes performing the RACH procedure using the default PRACH configuration based on performing an initial access procedure, based on the indication for the activation state for PRACH adaptation, or a combination thereof.

In certain aspects, method 1100 further includes sending, to the device, a selection parameter indicating for the device to perform the RACH procedure using the first PRACH configuration, the first PRACH configuration with the one or more PRACH adaptations applied, or an additional PRACH configuration included in the PRACH adaptation information.

In certain aspects, the indication of the activation state for PRACH adaptation in the first message indicates deactivation of the one or more PRACH adaptations; and the method 1100 further comprises: sending, to the device, an indication of an adaptation to the first PRACH configuration after receiving the message; applying the adaptation to the first PRACH configuration based at least in part on sending the indication; and sending, to the device, a second message comprising the PRACH adaptation information, wherein the indication of the activation state for PRACH adaptation in the second message indicates activation of the one or more PRACH adaptations.

In certain aspects, method 1100 further includes sending the indication of the adaptation via a DCI message, a MAC-CE, a RRC configuration message, or a combination thereof.

In certain aspects, method 1100 further includes refraining from sending a paging message if the indication of the activation state for PRACH adaptation is changed.

In certain aspects, the message comprises one or more of: a system information message and a RRC configuration message.

In certain aspects, method 1100 may be performed by the apparatus to realize one or more technical effects or solutions to the aforementioned technical problem(s). For example, based on method 1100, the apparatus may save energy by activating a PRACH adaptation by sending the indication of the activation state rather than sending one or more downlink messages indicating the PRACH adaptation. As described previously, one or more devices may attempt to connect to the apparatus, but the one or more devices may not have received a downlink message for a PRACH adaptation. Rather than the apparatus sending another downlink message for the PRACH adaptation to the one or more devices, the apparatus may save energy by indicating PRACH adaptation is active in a message that the one or more devices are configured to monitor (e.g., via the indication of the activation state for PRACH adaptation). Additionally, the apparatus may save energy by refraining from sending a paging message to the devices when changing the indication of the activation state for PRACH adaptation.

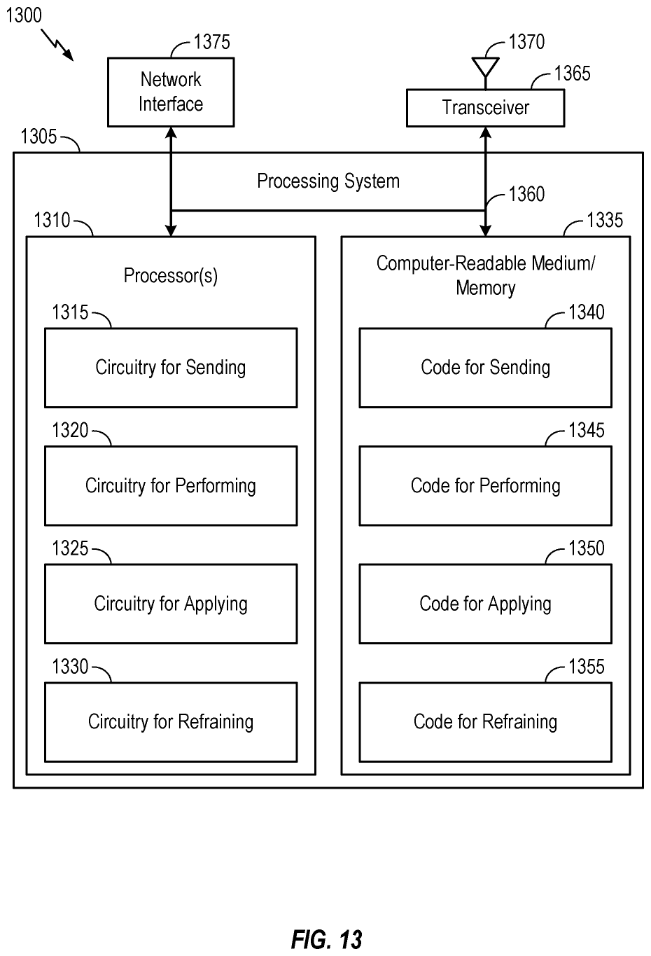

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor r 364, TX MIMO processor 366, and/or controller/processor 380, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, enable and cause the one or more processors 1210 to perform the method 900 described with respect to FIG. 9, or any aspect related to it, including any operations described in relation to FIG. 9; and the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code for receiving 1235, code for performing 1240, and code for applying 1245. Processing of the code 1235-1245 may enable and cause the communications device 1200 to perform the method 900 described with respect to FIG. 9, or any aspect related to it; and the method 1000 described with respect to FIG. 10, or any aspect related to it.

The one or more processors 1210 include circuitry configured to implement (e.g., execute) the code stored in the computer-readable medium/memory 1230, including circuitry for receiving 1215, circuitry for performing 1220, and circuitry for applying 1225. Processing with circuitry 1215-1225 may enable and cause the communications device 1200 to perform the method 900 described with respect to FIG. 9, or any aspect related to it; and the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the transceivers 354, antenna(s) 352, receive processor 358, AI processor 370, and/or controller/processor 380 of the UE 104 illustrated in FIG. 3, transceiver 1255 and/or antenna 1260 of the communications device 1200 in FIG. 12, and/or one or more processors 1210 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, enable and cause the one or more processors 1310 to perform the method 1100 described with respect to FIG. 11, or any aspect related to it, including any operations described in relation to FIG. 11. Note that reference to a processor of communications device 1300 performing a function may include one or more processors of communications device 1300 performing that function, such as in a distributed fashion.

In the depicted example, the computer-readable medium/memory 1335 stores code for sending 1340, code for performing 1345, code for applying 1350, and code for refraining 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for sending 1315, circuitry for performing 1320, circuitry for applying 1325, and circuitry for refraining 1330. Processing with circuitry 1315-1330 may enable and cause the communications device 1300 to perform the method 1100 described with respect to FIG. 11, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving or obtaining may include the transceivers 332, antenna(s) 334, receive processor 338, AI processor 318, and/or controller/processor 340 of the BS 102 illustrated in FIG. 3, transceiver 1365, antenna 1370, and/or network interface 1375 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by an apparatus comprising: receiving, from a network entity, a first message comprising PRACH adaptation information, the PRACH adaptation information comprising: a first PRACH configuration; and an indication of an activation state for PRACH adaptation, wherein the indication of the activation state for PRACH adaptation indicates activation or deactivation of one or more PRACH adaptations; and performing a RACH procedure based on the PRACH adaptation information.

Clause 2: The method of Clause 1, wherein the PRACH adaptation information further comprises: a plurality of PRACH adaptation configurations; and an indication of an active PRACH adaptation configuration of the plurality of PRACH adaptation configurations.

Clause 3: The method of any one of Clauses 1-2, wherein: the PRACH adaptation information further comprises one or more additional PRACH configurations; and the method further comprises performing the RACH procedure using a PRACH configuration of the one or more additional PRACH configurations based at least in part on the indication of the activation state for PRACH adaptation.

Clause 4: The method of Clause 3, further comprising receiving, from the network entity, a selection parameter indicating the PRACH configuration of the one or more additional PRACH configurations.

Clause 5: The method of any one of Clauses 1-4, wherein: the PRACH adaptation information further comprises one or more PRACH adaptation parameters for the first PRACH configuration; and the method further comprises applying the one or more PRACH adaptation parameters to the first PRACH configuration based at least in part on the indication of the activation state for PRACH adaptation.

Clause 6: The method of Clause 5, wherein: the first PRACH configuration comprises a plurality of occasions for performing the RACH procedure; and the one or more PRACH adaptation parameters comprise a periodicity of the plurality of occasions, a number of occasions configured for the plurality of occasions, a number of synchronization blocks configured per occasion of the plurality of occasions, a bitmap indicating one or more occasions of the plurality of occasions that are not to be used for RACH procedures, or a combination thereof.

Clause 7: The method of any one of Clauses 1-6, further comprising receiving, from the network entity, an additional message comprising an indication of a time period for which the indication of the activation state for PRACH adaptation is valid.

Clause 8: The method of Clause 7, further comprising receiving, from the network entity, a system information update message indicating one or more updates have been made to a system information message, wherein the time period is shortened based at least in part on receiving the system information update message.

Clause 9: The method of any one of Clauses 1-8, wherein the PRACH adaptation information further comprises a default PRACH configuration.

Clause 10: The method of Clause 9, further comprising performing the RACH procedure using the default PRACH configuration based on performing an initial access procedure, based on the indication for the activation state for PRACH adaptation, or a combination thereof.

Clause 11: The method of any one of Clauses 1-10, further comprising receiving, from the network entity, a selection parameter indicating for the apparatus to perform the RACH procedure using the first PRACH configuration, the first PRACH configuration with the one or more PRACH adaptations applied, or an additional PRACH configuration included in the PRACH adaptation information.

Clause 12: The method of any one of Clauses 1-11, wherein: the indication of the activation state for PRACH adaptation in the first message indicates deactivation of the one or more PRACH adaptations; and the method further comprises: receiving, from the network entity, an indication of an adaptation to the first PRACH configuration after receiving the message; applying the adaptation to the first PRACH configuration based at least in part on receiving the indication; and receiving, from the network entity, a second message comprising the PRACH adaptation information, wherein the indication of the activation state for PRACH adaptation in the second message indicates activation of the one or more PRACH adaptations.

Clause 13: The method of Clause 12, further comprising receiving the indication of the adaptation via one or more of: a DCI message, a MAC-CE, and a RRC configuration message.

Clause 14: The method of any one of Clauses 1-13, further comprising not expecting to receive a paging message if the indication of the activation state for PRACH adaptation is changed.

Clause 15: The method of any one of Clauses 1-14, wherein the first message comprises one or more of: a system information message and a RRC configuration message.

Clause 16: A method for wireless communications by an apparatus comprising: receiving, from a network entity, a message comprising PRACH adaptation information, the PRACH adaptation information comprising: a default PRACH configuration; an indication of an activation state for PRACH adaptation, wherein the indication of the activation state for PRACH adaptation indicates activation or deactivation of one or more PRACH adaptations; and an indication of a time period for which the indication of the activation state for PRACH adaptation is valid; performing one or more RACH in accordance with the indication of the activation state for PRACH adaptation prior to the time period elapsing; and receiving, from the network entity, a system information update message indicating one or more updates have been made to a system information message, wherein the time period is shortened based at least in part on receiving the system information update message.

Clause 17: A method for wireless communications by an apparatus comprising: sending, to a device, a first message comprising PRACH adaptation information, the PRACH adaptation information comprising: a first PRACH configuration; and an indication of an activation state for PRACH adaptation, wherein the indication of the activation state for PRACH adaptation indicates activation or deactivation of one or more PRACH adaptations; and performing a RACH procedure with the device based on the PRACH adaptation information.

Clause 18: The method of Clause 17, wherein the PRACH adaptation information further comprises: a plurality of PRACH adaptation configurations; and an indication of an active PRACH adaptation configuration of the plurality of PRACH adaptation configurations.

Clause 19: The method of any one of Clauses 17-18, wherein: the PRACH adaptation information further comprises one or more additional PRACH configurations; and the method further comprises sending the indication of the activation state for PRACH adaptation to indicate for the device to perform the RACH procedure using a PRACH configuration of the one or more additional PRACH configurations.

Clause 20: The method of Clause 19, further comprising sending, to the device, a selection parameter indicating the PRACH configuration of the one or more additional PRACH configurations.

Clause 21: The method of any one of Clauses 17-20, wherein: the PRACH adaptation information further comprises one or more PRACH adaptation parameters for the first PRACH configuration; and the method further comprises sending the indication of the activation state for PRACH adaptation to indicate for the device to apply the one or more PRACH adaptation parameters to the first PRACH configuration.

Clause 22: The method of Clause 21, wherein: the first PRACH configuration comprises a plurality of occasions for performing the RACH procedure; and the one or more PRACH adaptation parameters comprise a periodicity of the plurality of occasions, a number of occasions configured for the plurality of occasions, a number of synchronization blocks configured per occasion of the plurality of occasions, a bitmap indicating one or more occasions of the plurality of occasions that are not to be used for RACH procedures, or a combination thereof.

Clause 23: The method of any one of Clauses 17-22, further comprising sending, to the device, an additional message comprising an indication of a time period for which the indication of the activation state for PRACH adaptation is valid.

Clause 24: The method of Clause 23, further comprising sending, to the device, a system information update message indicating one or more updates have been made to a system information message, wherein the time period is shortened based at least in part on sending the system information update message.

Clause 25: The method of any one of Clauses 17-24, wherein the PRACH adaptation information further comprises a default PRACH configuration.

Clause 26: The method of Clause 25, further comprising performing the RACH procedure using the default PRACH configuration based on performing an initial access procedure, based on the indication for the activation state for PRACH adaptation, or a combination thereof.

Clause 27: The method of any one of Clauses 17-26, further comprising sending, to the device, a selection parameter indicating for the device to perform the RACH procedure using the first PRACH configuration, the first PRACH configuration with the one or more PRACH adaptations applied, or an additional PRACH configuration included in the PRACH adaptation information.

Clause 28: The method of any one of Clauses 17-27, wherein: the indication of the activation state for PRACH adaptation in the first message indicates deactivation of the one or more PRACH adaptations; and the method further comprises: sending, to the device, an indication of an adaptation to the first PRACH configuration after receiving the message; applying the adaptation to the first PRACH configuration based at least in part on sending the indication; and sending, to the device, a second message comprising the PRACH adaptation information, wherein the indication of the activation state for PRACH adaptation in the second message indicates activation of the one or more PRACH adaptations.

Clause 29: The method of Clause 28, further comprising sending the indication of the adaptation via one or more of: a DCI message, a MAC-CE, and a RRC configuration message.

Clause 30: The method of any one of Clauses 17-29, further comprising refraining from sending a paging message if the indication of the activation state for PRACH adaptation is changed.

Clause 31: The method of any one of Clauses 17-30, wherein the message comprises one or more of: a system information message and a RRC configuration message.

Clause 32: One or more apparatuses, comprising: one or more memories comprising executable instructions; and one or more processors configured to execute the executable instructions and cause the one or more apparatuses to perform a method in accordance with any one of Clauses 1-31.

Clause 33: One or more apparatuses, comprising: one or more memories; and one or more processors, coupled to the one or more memories, configured to cause the one or more apparatuses to perform a method in accordance with any one of Clauses 1-31.

Clause 34: One or more apparatuses, comprising: one or more memories; and one or more processors, coupled to the one or more memories, configured to perform a method in accordance with any one of Clauses 1-31.

Clause 35: One or more apparatuses, comprising means for performing a method in accordance with any one of Clauses 1-31.

Clause 36: One or more non-transitory computer-readable media comprising executable instructions that, when executed by one or more processors of one or more apparatuses, cause the one or more apparatuses to perform a method in accordance with any one of Clauses 1-31.

Clause 37: One or more computer program products embodied on one or more computer-readable storage media comprising code for performing a method in accordance with any one of Clauses 1-31.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories; and one or more processors coupled to the one or more memories and configured to cause the apparatus to:
receive, from a network entity, a first message comprising physical random access channel (PRACH) adaptation information, the PRACH adaptation information comprising:
a first PRACH configuration; and
an indication of an activation state for PRACH adaptation, wherein the indication of the activation state for PRACH adaptation indicates activation or deactivation of one or more PRACH adaptations; and
perform a random access channel (RACH) procedure based on the PRACH adaptation information.

2. The apparatus of claim 1, wherein the PRACH adaptation information further comprises:
a plurality of PRACH adaptation configurations; and
an indication of an active PRACH adaptation configuration of the plurality of PRACH adaptation configurations.

3. The apparatus of claim 1, wherein:
the PRACH adaptation information further comprises one or more additional PRACH configurations; and
the one or more processors are configured to cause the apparatus to perform the RACH procedure using a PRACH configuration of the one or more additional PRACH configurations based at least in part on the indication of the activation state for PRACH adaptation.

4. The apparatus of claim 3, wherein the one or more processors are configured to cause the apparatus to receive, from the network entity, a selection parameter indicating the PRACH configuration of the one or more additional PRACH configurations.

5. The apparatus of claim 1, wherein:
the PRACH adaptation information further comprises one or more PRACH adaptation parameters for the first PRACH configuration; and
the one or more processors are configured to cause the apparatus to apply the one or more PRACH adaptation parameters to the first PRACH configuration based at least in part on the indication of the activation state for PRACH adaptation.

6. The apparatus of claim 5, wherein:
the first PRACH configuration comprises a plurality of occasions for performing the RACH procedure; and
the one or more PRACH adaptation parameters comprise a periodicity of the plurality of occasions, a number of occasions configured for the plurality of occasions, a number of synchronization blocks configured per occasion of the plurality of occasions, a bitmap indicating one or more occasions of the plurality of occasions that are not to be used for RACH procedures, or a combination thereof.

7. The apparatus of claim 1, wherein the one or more processors are configured to cause the apparatus to receive, from the network entity, an additional message comprising an indication of a time period for which the indication of the activation state for PRACH adaptation is valid.

8. The apparatus of claim 7, wherein the one or more processors are configured to cause the apparatus to receive, from the network entity, a system information update message indicating one or more updates have been made to a system information message, wherein the time period is shortened based at least in part on receiving the system information update message.

9. The apparatus of claim 1, wherein the PRACH adaptation information further comprises a default PRACH configuration.

10. The apparatus of claim 9, wherein the one or more processors are configured to cause the apparatus to perform the RACH procedure using the default PRACH configuration based on performing an initial access procedure, based on the indication for the activation state for PRACH adaptation, or a combination thereof.

11. The apparatus of claim 1, wherein the one or more processors are configured to cause the apparatus to receive, from the network entity, a selection parameter indicating for the apparatus to perform the RACH procedure using the first PRACH configuration, the first PRACH configuration with the one or more PRACH adaptations applied, or an additional PRACH configuration included in the PRACH adaptation information.

12. The apparatus of claim 1, wherein:
the indication of the activation state for PRACH adaptation in the first message indicates deactivation of the one or more PRACH adaptations; and
the one or more processors are configured to cause the apparatus to:
receive, from the network entity, an indication of an adaptation to the first PRACH configuration after receiving the message;
apply the adaptation to the first PRACH configuration based at least in part on receiving the indication; and
receive, from the network entity, a second message comprising the PRACH adaptation information, wherein the indication of the activation state for PRACH adaptation in the second message indicates activation of the one or more PRACH adaptations.

13. The apparatus of claim 12, wherein the one or more processors are configured to cause the apparatus to receive the indication of the adaptation via one or more of: a downlink control information (DCI) message, a medium access control (MAC) control element (CE), and a radio resource control (RRC) configuration message.

14. The apparatus of claim 1, wherein the one or more processors are configured to cause the apparatus to not expect to receive a paging message if the indication of the activation state for PRACH adaptation is changed.

15. The apparatus of claim 1, wherein the first message comprises one or more of: a system information message and a radio resource control (RRC) configuration message.

16. An apparatus configured for wireless communications, comprising: one or more memories; and one or more processors coupled to the one or more memories and configured to cause the apparatus to:
receive, from a network entity, a message comprising physical random access channel (PRACH) adaptation information, the PRACH adaptation information comprising:
a default PRACH configuration;
an indication of an activation state for PRACH adaptation, wherein the indication of the activation state for PRACH adaptation indicates activation or deactivation of one or more PRACH adaptations; and
an indication of a time period for which the indication of the activation state for PRACH adaptation is valid;
perform one or more random access channel (RACH) in accordance with the indication of the activation state for PRACH adaptation prior to the time period elapsing; and
receive, from the network entity, a system information update message indicating one or more updates have been made to a system information message, wherein the time period is shortened based at least in part on receiving the system information update message.

17. A method for wireless communications by an apparatus comprising:
receiving, from a network entity, a first message comprising physical random access channel (PRACH) adaptation information, the PRACH adaptation information comprising:
a first PRACH configuration; and
an indication of an activation state for PRACH adaptation, wherein the indication of the activation state for PRACH adaptation indicates activation or deactivation of one or more PRACH adaptations; and
performing a random access channel (RACH) procedure based on the PRACH adaptation information.

18. The method of claim 17, wherein the PRACH adaptation information further comprises:
a plurality of PRACH adaptation configurations; and
an indication of an active PRACH adaptation configuration of the plurality of PRACH adaptation configurations.

19. The method of claim 17, wherein:
the PRACH adaptation information further comprises one or more additional PRACH configurations; and
to the method further comprises performing the RACH procedure using a PRACH configuration of the one or more additional PRACH configurations based at least in part on the indication of the activation state for PRACH adaptation.

20. The method of claim 17, wherein:
the PRACH adaptation information further comprises one or more PRACH adaptation parameters for the first PRACH configuration; and
to the method further comprises applying the one or more PRACH adaptation parameters to the first PRACH configuration based at least in part on the indication of the activation state for PRACH adaptation.
